(19) United States
(12) Patent Application Publication
(10) Pub. No.: US 2010/0098825 A1
(43) Pub. Date: Apr. 22, 2010

(54) FOOD PRODUCT HANDLING DEVICE

(75) Inventors: LOREN VELTROP, CHICAGO, IL (US); DON VAN ERDEN, WILDWOOD, IL (US); MICHAEL M. MACIEJEWSKI, SAINT CHARLES, IL (US)

Correspondence Address: Docket Clerk, 1000 JORIE BOULEVARD SUITE 144, OAK BROOK, IL, 60523, US

(73) Assignee: PRINCE CASTLE INC., CAROL STREAM, IL (US)

(21) Appl. No.: 12/254,066

(22) Filed: Oct. 20, 2008

(51) Int. Cl. A21D 13/00; A47J 37/06; A47J 27/04

(52) U.S. Cl. 426/505; 426/511; 426/523; 99/355

(57) ABSTRACT

A spatula (200, 700, 900) has a platform (201, 701, 901) having an opening bounded by a food support (205, 217, 221, 223). At least a part of the food support (205, 217, 221, 223) supports a food product, such as a bread product, for steaming or toasting. An optional guide (209, 609, 909) is disposed on one side of the platform (201, 701, 901). The guide (209, 609, 909) is configured to align the food product with a package (501) arranged and sized to contain at least the food product. The platform (201, 701, 901) optionally has one or more segments (703, 705) that rotate away from the platform (201, 701, 901).

### FIELD OF THE INVENTION

This invention relates to apparatus utilized in food preparation, including but not limited to apparatus utilized in the processing, such as steaming or toasting, of food products such as bread-type food products, including buns, rolls, croissants, bagels, and the like, as well as pasta, vegetables, cakes, pastries, and so forth.

### BACKGROUND OF THE INVENTION

Restaurants often process bread-type food products, referred to hereinafter as bread products, ranging from bread slices to buns, rolls, croissants, bagels, and the like. Such processing may include steaming and/or toasting.

Steaming and toasting both involve heat, thus the bread product needs to be handled by a person from a safe distance when steaming and toasting. In large volume food handling operations, such as fast-food restaurants and drive-in restaurants, food preparation is performed quickly.

A known steamer is shown in FIG. 1. The bread product fits on a metal holder that slides into a compartment of the steamer.

Accordingly, there is a need for a device that can safely hold a bread product in a hot environment, while able to be operated in a quick and simple way.

### BRIEF DESCRIPTION OF THE DRAWINGS

FIG. 1 shows a known steamer for a bread product.

FIG. 2 is a top view of a spatula in accordance with the invention.

FIG. 3 is a bottom view of a spatula in accordance with the invention.

FIG. 4 is a side view showing the spatula disposed on a steamer in accordance with the invention.

FIG. 5 is a close-up view illustrating a guide for a package in accordance with the invention.

FIG. 6 is a close-up view illustrating an alternative guide for a package in accordance with the invention.

FIG. 7 and FIG. 8 are a perspective views of an alternative spatula disposed on a steamer in accordance with the invention.

FIG. 9 illustrates a bread product and a package for the bread product disposed on the alternative spatula in accordance with the invention.

FIG. 10 illustrates a bread product placed in a package by the spatula in accordance with the invention.

FIG. 11 illustrates the spatula being inserted into a hood on a steamer in accordance with the invention.

FIG. 12 and FIG. 13 illustrate a flexible cover utilized in conjunction with the spatula in accordance with the invention.

FIG. 14 is a flowchart illustrating a method of utilizing the spatula in accordance with the invention.

FIG. 15 is a flowchart illustrating an alternative method of utilizing the spatula in accordance with the invention.

### DESCRIPTION OF THE PREFERRED EMBODIMENT

The following describes an apparatus for and method of utilizing a spatula to process a food product, such as a bread product, for example, by steaming or toasting. The food product is disposed on the spatula, which optionally has a guide for a package for the food product. The spatula may have one or more rotatable segments to assist in removing the food product and/or the package. Although the specification describes embodiments of the invention as applied to bread products, the present invention may be applied to other food products, including pasta, vegetables, cakes, pastries, and so forth.

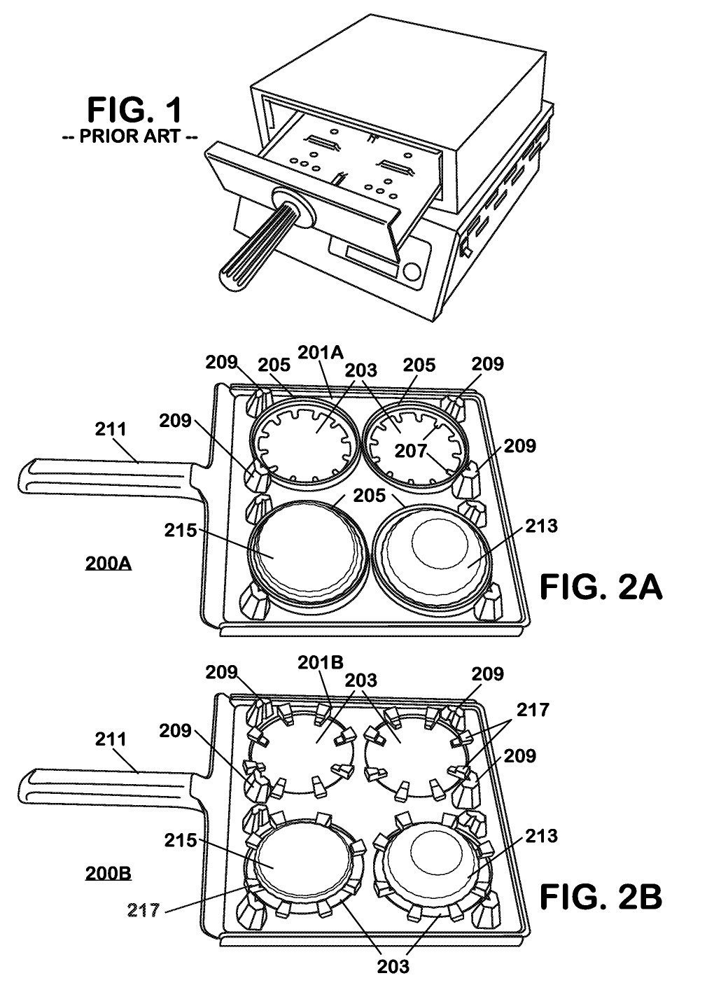

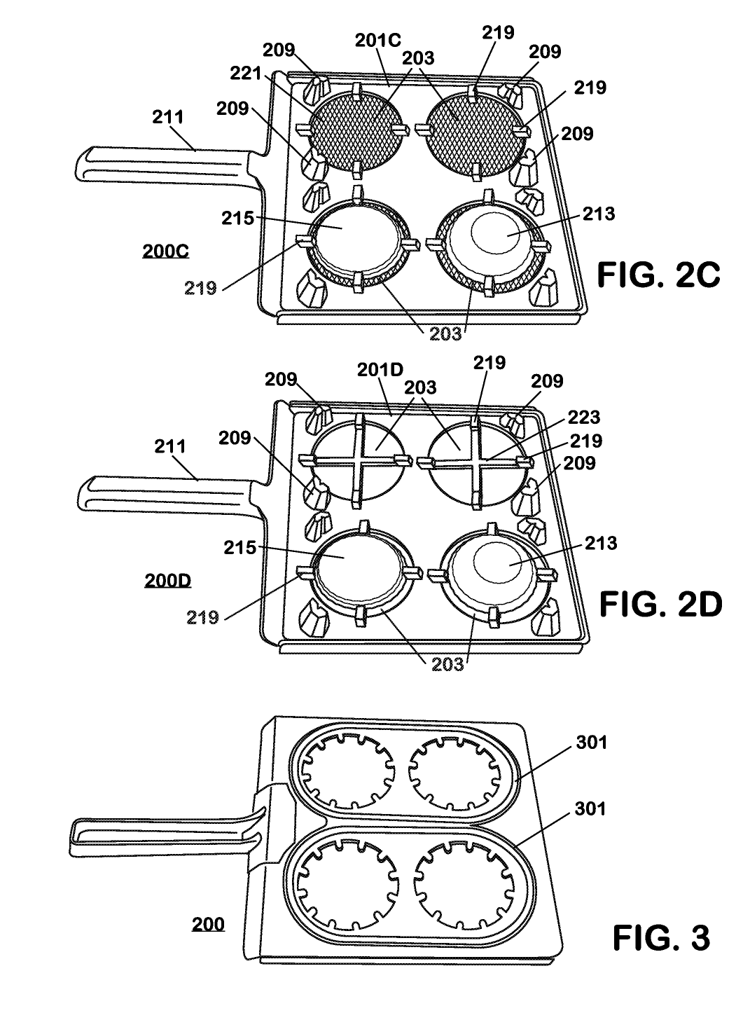

A top view of a spatula is shown in FIG. 2. FIG. 2 comprises FIG. 2A, FIG. 2B, FIG. 2C, and FIG. 2D, and reference numeral 200 collectively refers to 200A, 200B, 200C and 200D, and reference numeral 201 collectively refers to 201A, 201B, 201C and 201D. The spatula 200 includes a platform 201 in which one or more openings 203 are formed. A food support, such as a rim 205, fingers 217, mesh or screen 221, blades or rods 223, and so forth, is formed near each opening 203, such that at least a part of the food support supports a bread product. An example bread product comprising a bun having two sections 213, 215 is shown in FIG. 2A supported on two rims 205, where the sections 213, 215 are placed face down on the spatula 200. As shown in FIG. 2A, part of the rim 205 is horizontal, on which the bread product 213, 215 rests, and part of the rim 205 extends above the platform 201 to prevent the bread product from moving along the platform. A plurality of fingers 207 may optionally project into the opening to prevent the bread product 213, 215 from falling through the opening 203. The fingers 207 may be longer to facilitate holding various sizes and/or shapes of bread products 213, 215 on the same spatula 200.

The rim 205 depicted in FIG. 2A and other figures is considered to be one form of a food support in that the rim 205 supports a food product in the spatula 200, 700, 900. For purposes of clarity and simplicity, however, the description of FIG. 3 through FIG. 15 makes reference to the rim 205. Other food supports include fingers, tines, or blades 217, such as shown in FIG. 2B. The fingers, tines, or blades 217 are advantageously comprised of one or more plastics, such as that which the spatula 200, 700, 900 is made of, and/or metals, such as aluminum. The fingers, tines, or blades 217 may come to a sharper point than shown in FIG. 2B, and may take on shapes, such as triangles, (American) footballs, ovals, pies, spikes, and so forth, and may have sizes other than shown. The fingers, tines, or blades 217 may optionally be sharp enough to insert into a food product. The fingers, tines, or blades 217 may optionally comprise a multi-tiered structure, where the food product rests on an inner tier that advantageously centers the food product 213, 215. Another form of food support is a wire or plastic screen or mesh 221 that supports a food product as shown in FIG. 2C. Another embodiment of food support includes one or more wire or plastic rods 223 that extend partially or completely across the opening 203. Two or more posts 219 may optionally be utilized to center the food product with the opening 203, as shown in FIG. 2C and FIG. 2D. As shown in FIG. 2B, FIG. 2C, and FIG. 2D, air, steam, heat, and so forth are able to move through the opening 203 near the outer diameter of the food product 213, 215.

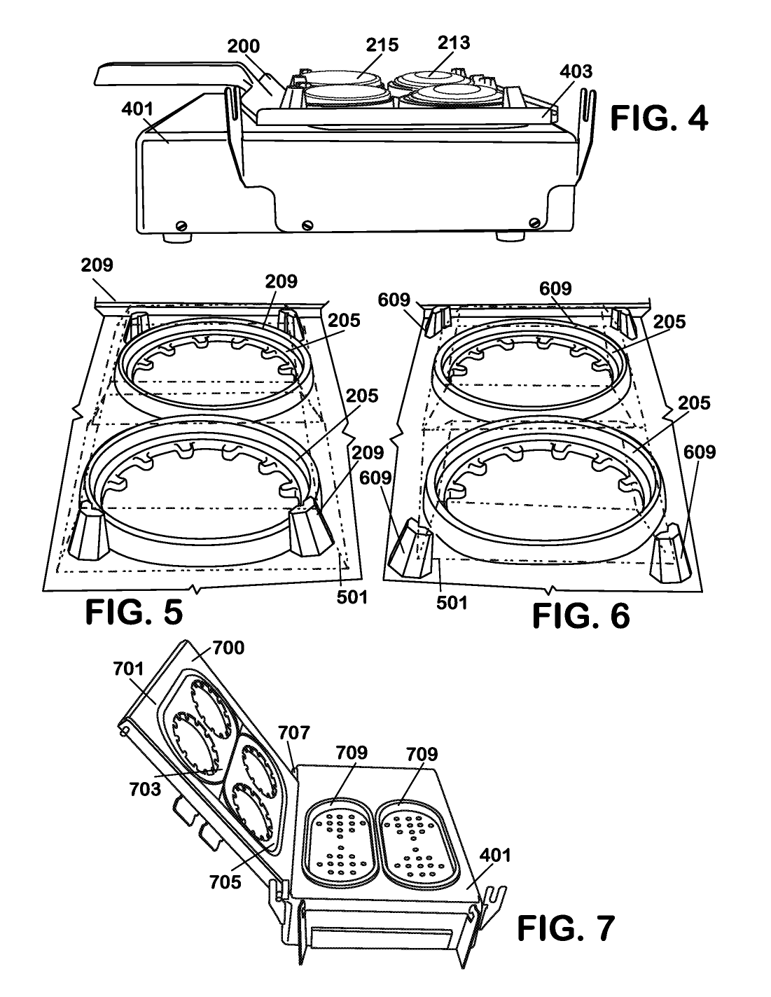

The spatula 200 may optionally include a guide 209 disposed on and extending from one side of the platform 201. The guide 209 is configured to align the bread product 213, 215 with a package 501 (see, e.g., FIG. 5 and FIG. 6) arranged and sized to contain at least the first bread product 213, 215. A handle 211 may optionally be utilized to hold the platform 201. The spatula 200, 700, 900 may optionally include one or more sealing mechanisms or gaskets 301, such as shown in the bottom view of FIG. 3, which may be comprised of a structure such as an elastomeric material, for example, rubber or plastic capable of operating in the applicable environment. The sealing mechanism or gasket 301 reduces leakage of steam between the bottom side of the platform 201, 701, 900 and a steamer 401 such as shown in FIG. 4. Each sealing mechanism or gasket 301 may be formed of multiple pieces or a single piece. The sealing mechanism or gasket 301 may be attached after the spatula 200, 700, 900 is formed or molded or may be integrated during the forming or molding process.

A side view showing the spatula 200 resting on the steamer 401 is shown in FIG. 4. A connection 403, such as a hinge or bracket, may optionally facilitate alignment between the spatula 200 and the steamer 401. The connection may be, for example, a rotational connection or a sliding connection. Although a steamer 401 is shown, the present application may be applied to other food processing devices, such as toasters, microwaves, convection ovens, ovens, and so forth.

A close-up view illustrating a guide 209 for a package 501 is shown in FIG. 5. The package 501 may be arranged and sized to fit plasticware, napkins, and/or additional food products to the bread product 213, 215, for example, food products that create a sandwich when combined with the bread product 213, 215 or toppings for a bread product 213, 215, such as butter, cream cheese, jelly, mustard, ketchup, and the like. The platform 201 optionally includes a guide that advantageously aligns a package 501 with the bread product 213, 215. The guide 209 may be arranged and constructed such that packages of different shapes fit with the guide 209. The guide 209 may be arranged and constructed such that a package of a specific shape fits with the guide 209.

The guide 209 may optionally provide a compression fit with the package. Optionally, if the fit between the guide 209 and package is tight enough, the bread product may be placed in the package 501, then the spatula 200, 700, 900 may be applied to the package(s) 501 and the items turned over for processing. In the embodiment of FIG. 5, the guide 209 comprises a plurality of posts, arranged and constructed to receive the first package. As shown in FIG. 5, four posts 209 disposed outside two rims 205 receive the outer four corners of a two-section package 501 outside the posts 209. In this embodiment, the posts 209 may guide the bread product 213, 215 into the package 501 when the bread product 213, 215 is removed from the spatula 200. As shown in the alternative embodiment in FIG. 6, the four posts 609 are disposed further outside two rims 205 and receive an outer surface of the package 501 inside the posts 209. A further embodiment, shown in FIG. 9, illustrates a guide 909 comprised of a frame disposed near an outer perimeter of the platform 901, such that the frame receives the outer surface of one or more packages. The guide 209, 609, 909 may be shaped to fit the contours of the package 501 or may take on any shape that guides the package 501.

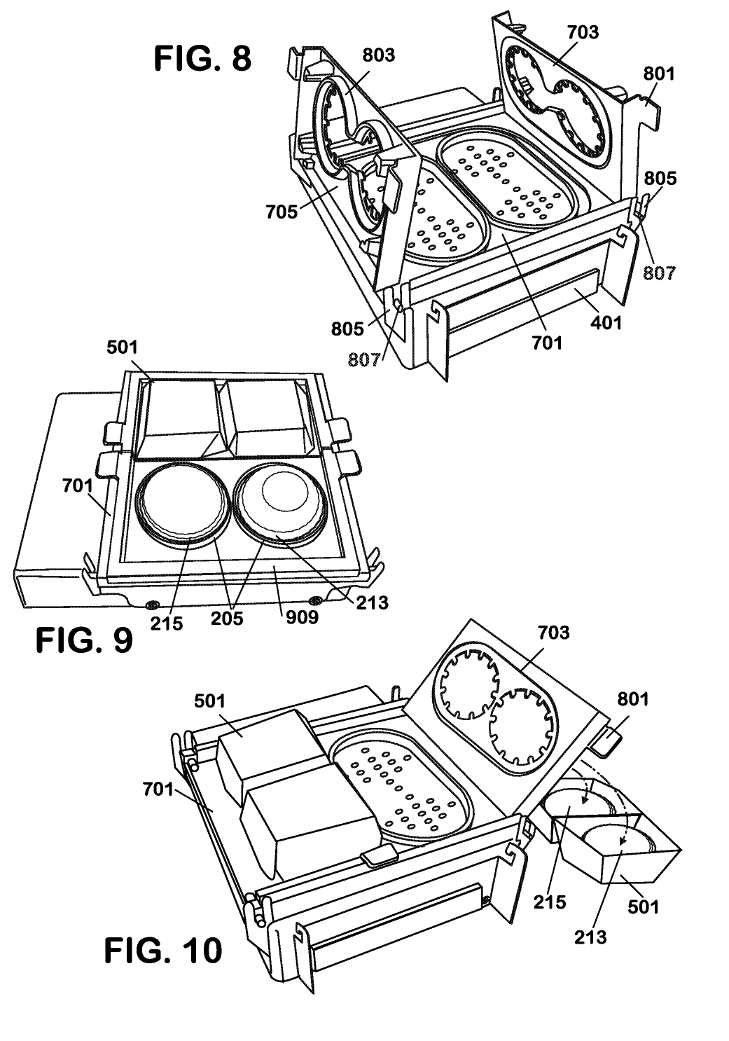

Perspective views of an alternative spatula 700 disposed on a steamer are shown in FIG. 7 and FIG. 8. The spatula 700 is similar to the spatula 200, in that it includes openings 203, rims 205, fingers 207, and guides 209, 609, 909. The spatula 701 differs in that the openings 203, rims 205, fingers 207, and guides 209, 609, 909 are disposed on one or more segments 703, 705 that rotate away from the platform 701. The segments 703, 705 may have a compression fit with the rest of the platform 701 when the segments are not rotated. The spatula 700 may optionally advantageously include a connection that facilitates a rotational connection between the platform and the steamer 401, for example, to align the openings 203 of the spatula 700 with the steaming chambers 709 of the steamer 401 (or toasting elements if a toaster is involved). Alternatively, the spatula 700 may include guide rods 807 that fit inside forks 805 operably connected to the steamer 401, thereby quickly and easily aligning the spatula 700 with the steamer in a manner that facilitates quick and easy removal of the spatula 700. FIG. 8 illustrates the platform 701 resting on a steamer, with one segment 703 rotated clockwise away from the platform 701 and another segment 705 rotated counterclockwise away from the platform 701. FIG. 8 also shows an alternative embodiment of a rim 803 that supports two bread products or two sections of a single bread product above a single opening. The spatula 700 may optionally include one or more grips 801 that facilitate rotation of the segments 703, 705.

A bread product and a package for the bread product disposed on the alternative spatula 700 are illustrated in FIG. 9. Bread products in sections 213, 215 are shown disposed on the rims 205 of the platform 901. A two-piece package 501 is shown covering one of the bread products 213, 215. The package 501 is received by an alternative guide 909 that is comprised of a frame disposed near an outer perimeter of the platform 901. As shown in FIG. 9, an interior part of the frame is capable of receiving an outer surface of two packages 501.

A bread product placed in a package by the spatula is illustrated in FIG. 10. One segment 703 of the platform 701 may be rotated by use of the grip 801 until the segment 703, package 501, and bread product 213, 215 are turned over, resulting in the package being right-side up and one section 213, 215 of the bread product being placed in each piece of the package in an orientation suitable for further processing, for example, by adding meat, cheese, condiments, and the like to produce a sandwich. A guide 209 disposed interior to the box may guide the bread product 213, 215 into the package 501 when the segment 703, 705 is turned over. The segments 703, 705 may be turned over simultaneously or at different times. Alternatively, a one-part bread product may be disposed on one rim 205 while a two-piece package 501 is disposed on it.

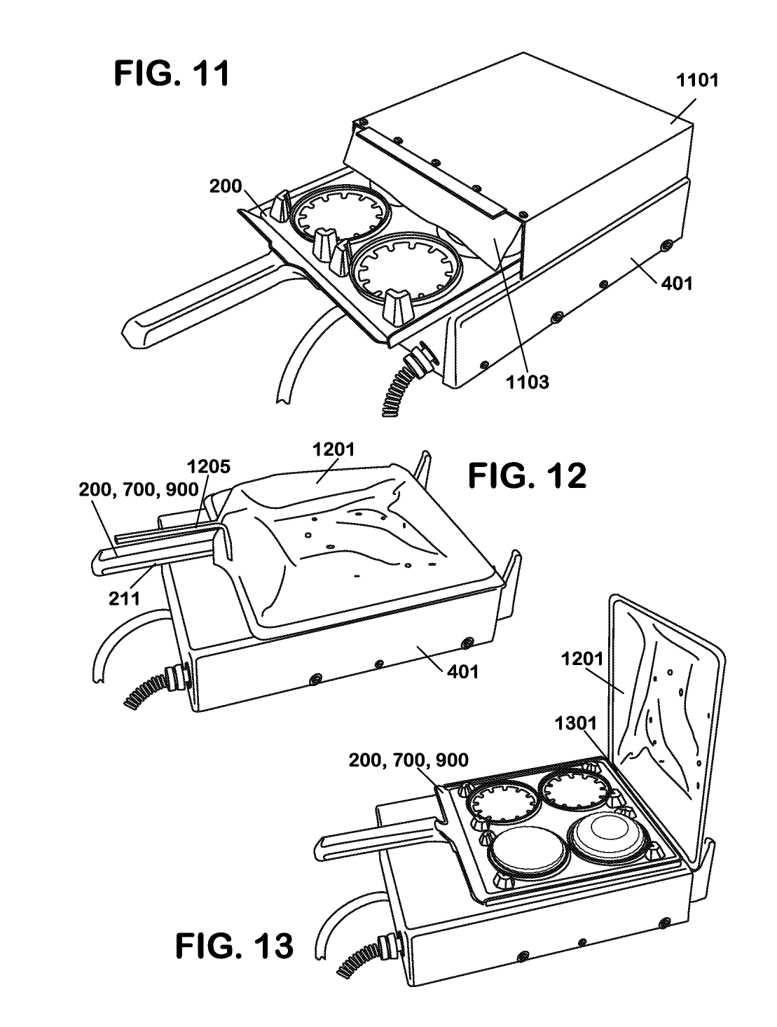

The bread product may be steamed, toasted, or otherwise processed in the package, under a hood, or both. One embodiment of a hood 1101 shown in FIG. 11 comprises a rectangular enclosure having a movable plate 1103, through which the spatula 200 and one or more bread products, and optionally one or more packages 501, enter the hood 1103. The hood 1101 is shown resting on the steamer 401, but may optionally be attached to the steamer 401, for example, with a single hinge such that the hood 1101 rotates or attached on three lower edges to the steamer 401. The hood 1101 may be comprised of one or more metals, one or more plastics, or a combination thereof.

An alternative hood in the form of a flexible cover 1201 is utilized in conjunction with the spatula 200, 700, 900 in FIG. 12 and FIG. 13. The flexible cover 1201 is operably coupled to a support 1203 that optionally is operably coupled to a handle 1205. If the spatula 200 has a handle 211, the handle 1205 of the hood may be advantageously aligned with that handle 211. The flexible cover 1201 is sized, shaped, and arranged to enclose the spatula 200, 700, 900, one or more bread products, and optionally one or more packages 501 above the steamer 401. The hood comprising the flexible cover 1201 may optionally include a connection 1301, such as a hinge, that facilitates a rotational connection between the hood and either the spatula 200, 700, 900 or the steamer 401 as shown in FIG. 13. The flexible cover 1201 and any support 1203 and/or handle 1205 may be comprised of one or more metals, one or more plastics, or any combination thereof. The flexible cover 1201 may be a metal or plastic mesh and may have a non-stick coating.

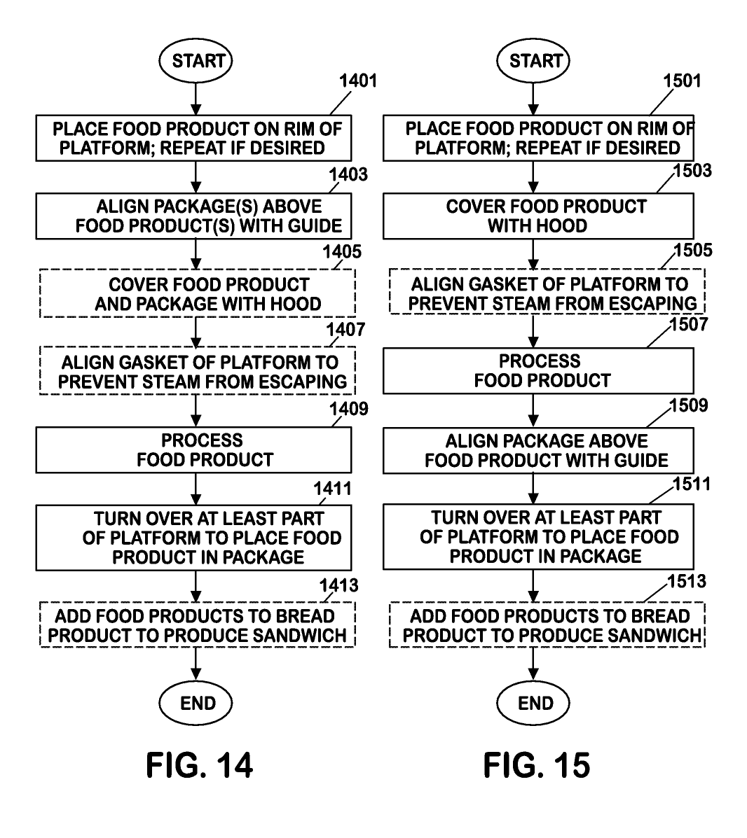

A flowchart illustrating a method of utilizing the spatula 200, 700, 900 is shown in FIG. 14. One or more food products, such as bread products comprising one or more sections 213, 215, are placed on one or more food supports, such as a rim 205, fingers, tines, or blades 217, mesh or screen 221, or rods 223, of the platform 201, 701, 901 at step 1401. The food products are optionally and advantageously centered over the openings 203 with the centering elements 205, 217, 219 of the food supports 205, 217, 221, 223, as described above. One or more packages 501 are aligned above the food product(s), such as a bread product, at step 1403 with a guide 209, 609, 909 as described above. The food product(s) and packages 501 may optionally be covered with a hood, as described above, at step 1405. Optionally, a sealing mechanism or gasket 301 on one side of the platform 201, 701, 901 may be aligned to prevent steam from escaping between a steamer 401 and the platform 201, 701, 901 at step 1407. The food product(s) are processed, for example, by steaming, toasting, warming, defrosting, spraying on liquid flavors, such as butter, injecting powders, such as spices, applying condiments, or otherwise processing at step 1409. The spatula 201, 701, 901 may optionally be utilized to transport the food product to another station. All of the platform 201 or part 703, 705, of the platform 701, 901 is turned over to place the food product in the package 501 at step 1411. Both segments 703, 705 may be turned over simultaneously or each segment 703, 705 may be turned over at different times. Each food product is advantageously placed in the package 501 in an orientation suitable for further processing, thus resulting in a quicker processing of the food product. Additional food products, such as described above, and optionally plasticware, napkins, and the like, may optionally be added at step 1413, e.g., to produce a sandwich when the food product is a bread product.

A flowchart illustrating an alternative method of utilizing the spatula 200, 700, 900 is shown in FIG. 15. One or more food products, such as bread products comprising one or more sections 213, 215, are placed on one or more food supports, such as a rim 205, fingers, tines, or blades 217, mesh or screen 221, or rods 223, of the platform 201, 701, 901 at step 1501. The food products are optionally and advantageously centered over the openings 203 with the centering elements 205, 217, 219 of the food supports 205, 217, 221, 223, as described above. The food product(s) is (are) covered with a hood, as described above, at step 1503. Optionally, a sealing mechanism or gasket 301 on one side of the platform 201, 701, 901 may be aligned to prevent steam from escaping between a steamer 401 and the platform 201, 701, 901 at step 1505. The food product(s) are processed, for example, by steaming, toasting, warming, defrosting, spraying on liquid flavors, such as butter, injecting powders, such as spices, applying condiments, or otherwise processing at step 1507. The spatula 201, 701, 901 may optionally be utilized to transport the food product to another station. One or more packages 501 are aligned above the food product(s) at step 1509 with a guide 209, 609, 909 as described above. All of the platform 201 or part 703, 705, of the platform 701, 901 is turned over to place the food product in the package 501 at step 1511. Both segments 703, 705 may be turned over simultaneously or each segment 703, 705 may be turned over at different times. Each food product is advantageously placed in the package 501 in an orientation suitable for further processing, thus resulting in a quicker processing of the food product. Additional food products, such as described above, and optionally plasticware, napkins, and the like, may optionally be added at step 1513, e.g., to produce a sandwich when the food product is a bread product.

The spatula 200, 700, 900 may be advantageously comprised of a material having low thermal conductivity. The spatula 200, 700, 900 may be advantageously comprised of at least one plastic, such as filled polypropylene, polycarbonate, or polyetherimide (such as Ultem® material). Although the drawings illustrate a steamer 401, the spatula 200, 700, 900 may also be utilized in conjunction with a toaster or other device for processing the bread product 213, 215. The spatula 200, 700, 900 may also be utilized in conjunction with a conveyor belt or other automation devices.

The spatula in its various embodiments as set forth herein has many advantages, including an easy to use device that can quickly be utilized to steam or toast a bread product in a fast-food environment. The spatula is lightweight and easy to manipulate. When made out of plastic or other thermally non-conductive material, the spatula will remain cooler than a metal cooler, thus the bread product may be substantially immediately handled after steaming or toasting without risking burning on a metal spatula. A plastic spatula is less expensive to manufacture than metal. The use of fingers extending into the openings in the spatula facilitate the easy acceptance different-sized products as well as preventing the bread product from falling through the opening. The use of a guide facilitates aligning the bread product with a package during steaming and to place the bread product in the package in an orientation ideal for further processing, including making a sandwich with the bread product. The spatula makes handling of food products such as bread products easy and convenient between and during processing steps, such as steaming, toasting, warming, defrosting, spraying of liquid flavors, adding spices, and applying condiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus comprising:
a platform having a first opening disposed with a first food support, wherein at least a part of the first food support supports a first food product for processing;
a guide disposed on a first side of the platform, wherein the guide is configured to align the first food product with a first package arranged and sized to contain at least the first food product.

2. The apparatus of claim 1, wherein the first food support is disposed on a first segment of the platform, which first segment rotates away from the platform.

3. The apparatus of claim 2, wherein, when the first segment is rotated, the first food product is placed in the first package in an orientation suitable for further processing of the first food product.

4. The apparatus of claim 1, wherein the platform is further arranged and constructed to support a second food product for steaming or toasting.

5. The apparatus of claim 2, wherein the platform further comprises a second opening disposed with a second food support, wherein at least a part of the second food support supports a second food product, and wherein the second food support is disposed on a second segment of the platform, which second segment rotates away from the platform.

6. The apparatus of claim 5, wherein the first segment rotates in a first direction, and the second segment rotates in a second direction, wherein the first direction and the second direction are different.

7. The apparatus of claim 1, wherein the first food product comprises a first section and a second section.

8. The apparatus of claim 7, wherein the platform further comprises a second opening disposed with a second food support, wherein the first section of the first food product wherein at least a part of the first food support supports the first section of the first food product and at least a part of the second food support supports the second section of the first food product.

9. The apparatus of claim 7, wherein at least a part of the first food support is arranged and configured to support the first section and the second section of the first food product.

10. The apparatus of claim 7, wherein the first package comprises a first piece and a second piece.

11. The apparatus of claim 1, wherein at least the first food support further comprises at least one of:
a rim;
a screen;
a mesh;
a finger projecting into the first opening;
a tine
a blade; and
a rod
to prevent the first food product from falling through the opening.

12. The apparatus of claim 1, further comprising a handle operably coupled to the platform.

13. The apparatus of claim 2, further comprising a grip operably coupled to the first segment.

14. The apparatus of claim 1, further comprising at least one sealing mechanism or gasket disposed around the first opening on a second side of the platform.

15. The apparatus of claim 14, wherein the at least one sealing mechanism or gasket prevents steam from escaping between a steamer and the second side of the platform.

16. The apparatus of claim 1, further comprising a connection that facilitates a rotational connection between the platform and a steamer or toaster.

17. The apparatus of claim 1, the apparatus sized and shaped to rest on a steamer or toaster.

18. The apparatus of claim 1, wherein the guide is arranged and constructed to fit with differently-shaped packages.

19. The apparatus of claim 1, wherein the guide is arranged and constructed to fit with a package having a specific shape.

20. The apparatus of claim 1, wherein the guide is arranged and constructed to provide a compression fit with the first package.

21. The apparatus of claim 1, wherein the guide comprises a plurality of posts, arranged and constructed to receive the first package.

22. The apparatus of claim 21, wherein the plurality of posts guide the first food product into the first package when at least part of the platform is turned over.

23. The apparatus of claim 21, wherein the plurality of posts are disposed outside the first food support, and wherein the first package is received outside the plurality of posts.

24. The apparatus of claim 21, wherein the plurality of posts are disposed outside the first food support, and wherein the first package is received inside the plurality of posts.

25. The apparatus of claim 1, wherein the guide comprises a frame disposed near an outer perimeter of the platform, wherein the frame is arranged and constructed to receive an outer surface of the first package.

26. The apparatus of claim 1, further comprising a hood, sized, shaped, and arranged to enclose the platform and the first food product above a steamer or toaster.

27. The apparatus of claim 26, wherein the hood comprises a rectangular enclosure having a movable plate, through which the platform and the first food product enter the hood.

28. The apparatus of claim 26, wherein the hood is further sized, shaped, and arranged to enclose the first package above the steamer or toaster.

29. The apparatus of claim 26, wherein the hood is comprised of at least one of metal and plastic.

30. The apparatus of claim 26, wherein the hood comprises a flexible cover operably coupled to a support, wherein the flexible cover is sized, shaped, and arranged to enclose the platform and the first food product above the steamer or toaster.

31. The apparatus of claim 30, further comprising a handle operable coupled to the support.

32. The apparatus of claim 30, wherein the hood has a rotatable connection to the platform.

33. The apparatus of claim 30, wherein the hood has a rotatable connection to the steamer or toaster.

34. The apparatus of claim 30, wherein the flexible cover has a non-stick coating.

35. The apparatus of claim 1, wherein the platform is comprised of a material having low thermal conductivity.

36. The apparatus of claim 1, wherein the platform is comprised of at least one plastic.

37. The apparatus of claim 1, wherein the food product comprises a bread product.

38. An apparatus comprising:
a platform having first segment, which first segment rotates away from the platform;
a first opening disposed with a first food support disposed on the first segment, wherein at least a part of the first food support supports a first food product for processing.

39. The apparatus of claim 38, wherein, when the first segment is rotated, the first food product is placed in the first package in an orientation suitable for further processing of the first food product.

40. The apparatus of claim 38, wherein the platform is further arranged and constructed to support a second food product for steaming or toasting.

41. The apparatus of claim 38, wherein the platform further comprises a second opening disposed with a second food support, wherein at least a part of the second food support supports a second food product, and wherein the second rim is disposed on a second segment of the platform, which second segment rotates away from the platform.

42. The apparatus of claim 41, wherein the first segment rotates in a first direction, and the second segment rotates in a second direction, wherein the first direction and the second direction are different.

43. The apparatus of claim 38, wherein the first food product comprises a first section and a second section.

44. The apparatus of claim 43, wherein the platform further comprises a second opening disposed with a second food support, wherein the first section of the first food product wherein at least a part of the first food support supports the first section of the first food product and at least a part of the second food support supports the second section of the first food product.

45. The apparatus of claim 43, wherein at least a part of the first food support is arranged and configured to support the first section and the second section of the first food product.

46. The apparatus of claim 38, wherein at least the first food support further comprises at least one of:
a rim;
a screen;
a mesh;
a finger projecting into the first opening;
a tine;
a blade; and
a rod
to prevent the first food product from falling through the opening.

47. The apparatus of claim 38, further comprising at least one sealing mechanism or gasket disposed around the first opening on a second side of the platform.

48. The apparatus of claim 38, further comprising a guide disposed on a first side of the platform, wherein the guide is configured to align the first food product with a first package arranged and sized to contain at least the first food product.

49. The apparatus of claim 48, wherein the guide arranged and constructed to fit with differently-shaped packages.

50. The apparatus of claim 48, wherein the guide is arranged and constructed to provide a compression fit with the first package.

51. The apparatus of claim 48, wherein the guide comprises a plurality of posts, arranged and constructed to receive the first package.

52. The apparatus of claim 51, wherein the plurality of posts are disposed outside the first food support, and wherein the first package is received outside the plurality of posts.

53. The apparatus of claim 51, wherein the plurality of posts are disposed outside the first food support, and wherein the first package is received inside the plurality of posts.

54. The apparatus of claim 48, wherein the guide comprises a frame disposed near an outer perimeter of the platform, wherein the frame is arranged and constructed to receive an outer surface of the first package.

55. The apparatus of claim 38, further comprising a hood, sized, shaped, and arranged to enclose the platform and the first food product above a steamer or toaster.

56. The apparatus of claim 55, wherein the hood comprises a rectangular enclosure having a movable plate, through which the platform and the first food product enter the hood.

57. The apparatus of claim 54, wherein the hood is further sized, shaped, and arranged to enclose the first package above the steamer or toaster.

58. The apparatus of claim 54, wherein the hood comprises a flexible cover operably coupled to a support, wherein the flexible cover is sized, shaped, and arranged to enclose the platform and the first food product above the steamer or toaster.

59. The apparatus of claim 38, wherein the food product comprises a bread product.

60. A platform comprising:
a first food support disposed with a first opening and disposed in a first rotatable segment of the platform, wherein at least a part of the first food support supports a first section of a first food product;
a second food support disposed with a second opening and disposed in the first rotatable segment of the platform, wherein at least a part of the second food support supports a second section of the first food product;
a first guide comprising a first plurality of posts disposed on a first side of the platform, wherein the first plurality of posts are distributed outside the first food support and the second food support, wherein the guide is configured to align the first food product with a first package arranged and sized to contain at least the first food product.

61. The platform of claim 60, wherein, when the first segment is rotated, the first food product is placed in the first package in an orientation suitable for further processing of the first food product.

62. The platform of claim 60, further comprising: a third food support disposed with a third opening and disposed in a second rotatable segment of the platform, wherein at least a part of the third food support supports a first section of a second food product;
a fourth food support disposed with a fourth opening and disposed in the second rotatable segment of the platform, wherein at least a part of the fourth food support supports a second section of the second food product;
a second guide comprising a second plurality of posts disposed on the first side of the platform, wherein the second plurality of posts are distributed outside the third food support and the fourth food support, wherein the second guide is configured to align the second food product with a second package arranged and sized to contain at least the second food product.

63. The platform of claim 62, wherein the first segment rotates in a first direction, and the second segment rotates in a second direction, wherein the first direction and the second direction are different.

64. The platform of claim 60, wherein at least the first food support further comprises at least one of:
a rim;
a screen;
a mesh;
a finger projecting into the first opening;
a tine;
a blade; and
a rod
to prevent the first food product from falling through the opening.

65. The platform of claim 60, further comprising a grip operably coupled to the first segment.

66. The platform of claim 60, further comprising at least one sealing mechanism or gasket disposed around the first opening and the second opening on a second side of the platform.

67. The platform of claim 60, wherein the first guide is arranged and constructed to provide a compression fit with the first package.

68. The platform of claim 62, wherein the second guide is arranged and constructed to provide a compression fit with the second package.

69. The platform of claim 60, wherein the plurality of posts guide the first food product into the first package when at least part of the platform is turned over.

70. The platform of claim 62, wherein the second plurality of posts guide the second food product into the second package when at least part of the platform is turned over.

71. The platform of claim 60, wherein the first plurality of posts are disposed outside the first food support, and wherein the first package is received inside the first plurality of posts.

72. The apparatus of claim 62, wherein the second plurality of posts are disposed outside the first food support, and wherein the second package is received inside the second plurality of posts.

73. The platform of claim 60, further comprising a hood, sized, shaped, and arranged to enclose at least the platform and the first food product above a steamer or toaster.

74. The platform of claim 62, further comprising a hood, sized, shaped, and arranged to enclose the platform, the first food product, and the second food product above a steamer or toaster.

75. The platform of claim 74, wherein the hood comprises a rectangular enclosure having a movable plate, through which the platform and the first food product enter the hood.

76. The platform of claim 74, wherein the hood comprises a rectangular enclosure having a movable plate, through which the platform, the first food product, and a second food product enter the hood.

77. The platform of claim 74, wherein the hood comprises a flexible cover operably coupled to a support, wherein the flexible cover is sized, shaped, and arranged to enclose the platform and at least one of the first food product and a second food product.

78. The platform of claim 60, wherein the food product comprises a bread product.

79. A method comprising the steps of:
placing a first food product on a first food support of a platform disposable on a steamer or toaster;
retaining the platform and the first food product between a hood and the steamer or toaster;
removing the platform and the first food product from between the hood and the steamer or toaster;
aligning a first package above the first food product and with a first guide that extends from the platform;
turning over at least a part of the first platform, such that the first food product is placed in the first package in an orientation suitable for further processing of the first food product.

80. The method of claim 79, further comprising the step of adding food products to the first food product to produce a sandwich.

81. The method of claim 79, wherein the step of turning over comprises rotating at least a part of the platform.

82. The method of claim 79, further comprising the step of aligning the platform with the steamer such that at least one sealing mechanism or gasket on one side of the steamer prevents steam from escaping between the steamer and the platform.

83. The method of claim 79, wherein the step of turning over comprises turning over a first segment comprising the first food support at a first time and turning over a second segment comprising the second food support at a second time.

84. The method of claim 79, wherein the step of turning over comprises rotating a first segment comprising the first food support in a first direction and rotating a second segment comprising the second food support in a second direction.

85. The method of claim 84, wherein the first direction is counterclockwise and the second direction is clockwise.

86. The method of claim 79, wherein the step of turning over comprises turning over the whole platform.

87. The method of claim 79, wherein the step of aligning comprises placing the first package outside a plurality of posts comprising the guide that is disposed outside the first food support.

88. The method of claim 79, wherein the step of placing comprises placing an inner part of a first section of the first food product on the first food support and placing an inner part of a second section of the first food product on a second food support of the platform.

89. The method of claim 79, wherein the step of placing comprises placing an inner part of a first section of the first food product on a first part of the first food support and placing an inner part of a second section of the first food product on a second part of the first food support.

90. The method of claim 79, wherein the hood is one of a solid enclosure and a flexible cover.

91. The method of claim 79, wherein the step of aligning occurs before the step of retaining.

92. The method of claim 76, wherein the food product comprises a bread product.

93. The method of claim 79, further comprising the steps of:
placing a second food product on a second food support of the platform;
retaining the platform, the first food product, and the second product between the hood and the steamer or toaster;
removing the platform, the first food product, and the second product from between the hood and the steamer or toaster;
aligning a second package above the second food product and with a second guide that extends from the platform;
turning over at least a part of the first platform, such that the second food product is placed in the second package in an orientation suitable for further processing of the second food product.

94. The method of claim 79, further comprising the step of centering the food product on the food support.

95. A method comprising the steps of:
placing a first food product on a first food support of a platform disposable on a processor;
aligning a first package above the first food product and with a first guide that extends from the platform;
processing the first food product;
turning over at least a part of the first platform, such that the first food product is placed in the first package in an orientation suitable for further processing of the first food product.

96. The method of claim 95, further comprising the step of adding food products to the first food product to produce a sandwich.

97. The method of claim 95, wherein the step of turning over comprises rotating at least a part of the platform.

98 The method of claim 95, further comprising the step of aligning the platform with the processor, which comprises a steamer, such that at least one sealing mechanism or gasket on one side of the steamer prevents steam from escaping between the steamer and the platform.

99. The method of claim 95, wherein the step of turning over comprises turning over a first segment comprising the first food support at a first time and turning over a second segment comprising the second food support at a second time.

100. The method of claim 95, wherein the step of turning over comprises rotating a first segment comprising the first food support in a first direction and rotating a second segment comprising the second food support in a second direction.

101. The method of claim 100, wherein the first direction is counterclockwise and the second direction is clockwise.

102. The method of claim 95, wherein the step of turning over comprises turning over the whole platform.

103. The method of claim 95, wherein the step of aligning comprises placing the first package outside a plurality of posts comprising the guide that is disposed outside the first food support.

104. The method of claim 95, wherein the step of placing comprises placing an inner part of a first section of the first food product on the first food support and placing an inner part of a second section of the first food product on a second food support of the platform.

105. The method of claim 95, wherein the step of placing comprises placing an inner part of a first section of the first food product on a first part of the first food support and placing an inner part of a second section of the first food product on a second part of the first food support.

106. The method of claim 95, further comprising the step of covering the first package and the first food product with a hood prior to the processing step.

107. The method of claim 106, wherein the hood is one of a solid enclosure and a flexible cover.

108. The method of claim 95, wherein the food product comprises a bread product.

109. The method of claim 95, further comprising the steps of:
placing a second food product on a second food support of the platform;
aligning a second package above the second food product and with a second guide that extends from the platform;
turning over at least a part of the first platform, such that the second food product is placed in the second package in an orientation suitable for further processing of the second food product.

110. The method of claim 95, further comprising the step of centering the food product on the food support.
